(19) United States
(12) Patent Application Publication
(10) Pub. No.: US 2007/0103753 A1
(43) Pub. Date: May 10, 2007

(54) Alignment of Holographic Images on Detector

(75) Inventors: Coen Theodorus Hubertus Liedenbaum, Eindhoven (NL); Jan Evert Van Der Werf, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/581,638

(22) PCT Filed: Nov. 26, 2004
(86) PCT No.: PCT/IB04/03937

§ 371 Date: Jun. 5, 2006

(30) Foreign Application Priority Data
Dec. 8, 2003 (EP) 03078840.0
Jul. 28, 2004 (EP) 04300487.8

(51) Int. Cl. G02B 26/08

(52) U.S. Cl. 359/201

(57) ABSTRACT

The invention relates to an optical holographic device for reading out a data page recorded in a holographic medium (106). The device comprises means (104, 105) for forming an imaged data page, means for detecting (114) the imaged data page, means for detecting a Moiré pattern in the detected imaged data page and means for modifying the imaged data page as a function of the Moiré pattern.

### FIELD OF THE INVENTION

The present invention relates to an optical holographic device for reading out a data page recorded in a holographic medium, to a method for reading out such a data page and to a computer program for carrying out such a method.

### BACKGROUND OF THE INVENTION

An optical device capable of recording on and reading from a holographic medium is known from H. J. Coufal, D. Psaltis, G. T. Sincerbox (Eds.), ‘Holographic data storage’, Springer series in optical sciences, (2000). FIG. 1 shows such an optical device using phase conjugate read out. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator comprises transmissive areas and absorbent areas, which corresponds to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kind of multiplexing, such as shift multiplexing, may also be used for recording data pages in the holographic medium 106.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels, each pixel corresponding to a bit of the imaged data page. As a consequence, the imaged data page should be carefully aligned with the detector 114, in such a way that a bit of the imaged data page impinges on the corresponding pixel of the detector 114. Now, there are many degrees of freedom in the system, so that the imaged data page is not always carefully aligned with the detector 114. For example, a displacement of the holographic medium 106 with respect to the detector 114, in a direction perpendicular to the axis of the reconstructed signal beam, leads to a translational misalignment. A rotation of the holographic medium 106 or the detector 114 leads to an angular error between the imaged data page and the detector 114. A displacement of the holographic medium 106 with respect to the detector 114, in a direction parallel to the axis of the reconstructed signal beam, leads to a magnification error, which means that the size of a bit of the imaged data page is different from the size of a pixel of the detector 114.

Methods have been proposed in order to detect such errors. One of these methods, for example, makes use of alignment marks embedded in the holographic medium 106. They are detected and the holographic medium is translated and rotated until the right alignment marks are retrieved on the detector 114. This is described, for example, in U.S. Pat. No. 5,838,650. However, such a detection method is not suitable for a high-density holographic medium, because the alignment marks require space in the holographic medium, which reduces the possible data density.

### SUMMARY OF THE INVENTION

It is an object of the invention to provide a holographic device which can read a holographic medium with an increased data density.

To this end, the invention proposes an optical holographic device for reading out a data page recorded in a holographic medium, said device comprising means for forming an imaged data page from said data page, means for detecting said imaged data page, means for detecting a Moiré pattern in said detected imaged data page and means for modifying said imaged data page as a function of said Moiré pattern.

According to the invention, information about alignment errors is detected in the detected imaged data page directly. As a consequence, no additional alignment marks are required, which allows increasing the data density of the holographic medium. As will be explained in detail in the description, an error of magnification, translation or rotation in the imaged data page gives rise to a Moiré pattern in the detected imaged data page. This Moiré pattern thus provides an information about these errors. Detection and analyse of said Moiré pattern allows correcting these errors, by modification of the imaged data page, for example in that the holographic medium is displaced with respect to the detector.

Advantageously, the means for detecting the Moiré pattern comprise means for filtering high frequency components of the detected imaged data page. This simplifies the detection of the Moiré patterns, thus simplifying the signal processing of the detected imaged data page.

Preferably, the holographic device further comprises means for measuring a contrast in the detected imaged data page, the means for modifying the imaged data page being further controlled by said contrast. This allows further correcting a focus error of the imaged data page.

The invention also relates to a method for reading out a data page recorded in a holographic medium, said method comprising a step of forming an imaged data page from said data page, a step of detecting said imaged data page, a step of detecting a Moiré pattern in said detected imaged data page and a step of modifying said imaged data page as a function of said Moiré pattern.

The invention further relates to a computer program comprising a set of instructions which, when loaded into a processor or a computer, causes the processor or the computer to carry out this method.

### BRIEF DESCRIPTION OF THE DRAWINGS

The invention will now be described in more detail by way of example with reference to the accompanying drawings, in which:

FIG. 1 shows a holographic device in accordance with the prior art;

FIG. 2a shows an imaged data page and FIG. 2b shows a pixelated detector;

FIGS. 3a and 3b diagrammatically shows how a Moiré pattern is detected and analysed;

FIGS. 4a to 4c illustrate Moiré patterns as a consequence of an angular error;

FIG. 5a to 5c illustrate Moiré patterns as a consequence of a magnification error;

FIG. 6 illustrates a Moiré pattern in a filtered detected imaged data page;

FIG. 7a to 7c illustrate Moiré patterns as a consequence of a translation error;

FIG. 8 is a flowchart illustrating the method in accordance with the invention.

### DETAILED DESCRIPTION OF THE INVENTION

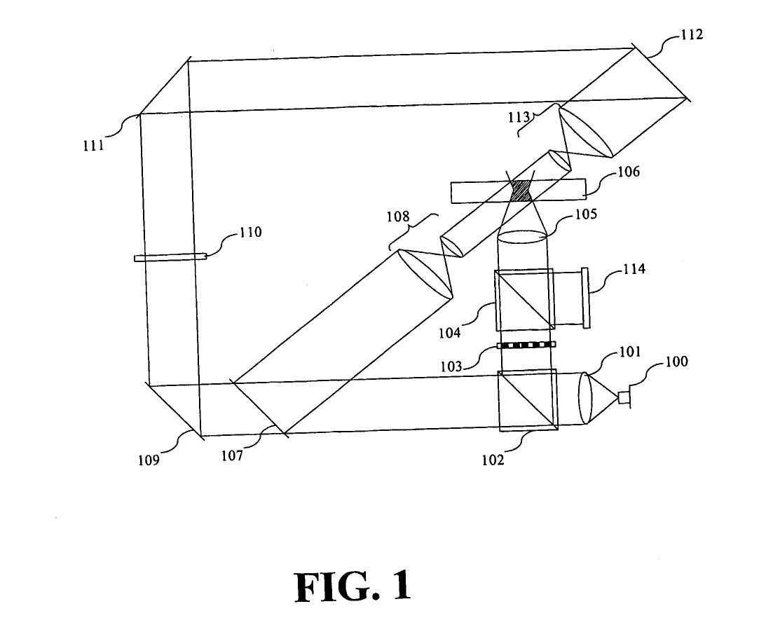

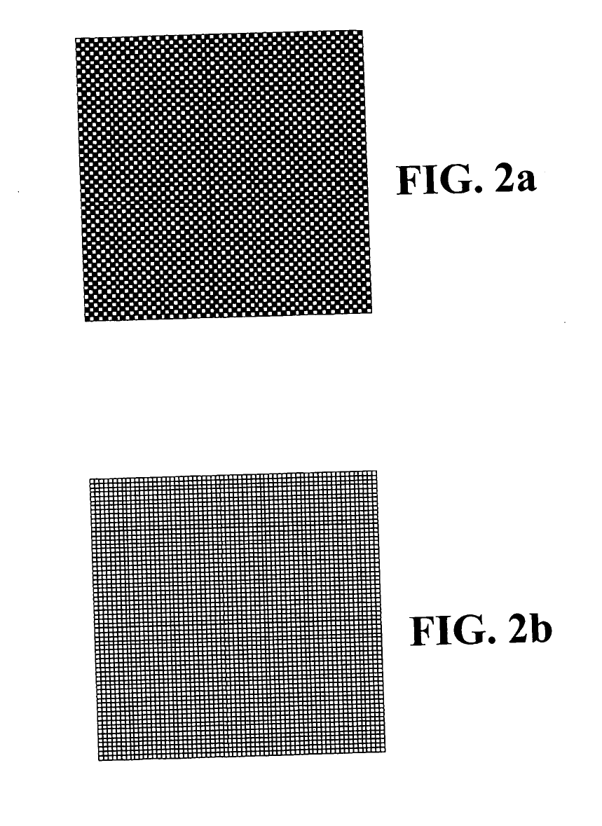

An imaged data page is depicted in FIG. 2a. This imaged data page comprises bits, which correspond to the data that have been sent to the spatial light modulator 103 during recording of the data page. In this example, the bits have a binary intensity, but more than two grey levels may be used in a data page. FIG. 2b shows the detector 114 of FIG. 1. This detector 114 comprises pixels, which size is equal to the size of a bit of the imaged data page. As a consequence, a bit of the imaged data page impinges on a corresponding pixel of the detector 114. The intensity of this bit is detected, and the data page is thus retrieved.

However, if a translational, rotational or magnification error occurs in the holographic device, a bit of the imaged data page may not impinge on its corresponding pixel. For example, if a translational error occurs between the imaged data page and the detector 114, with a quantity equal to one half pixel, then every bits impinges on two adjacent pixels, which leads to errors in the retrieval of the data page.

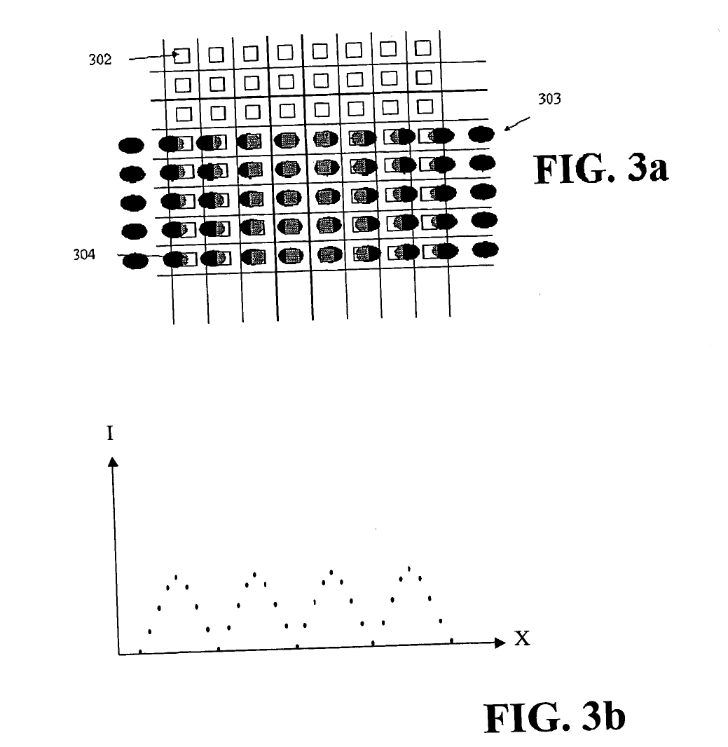

FIG. 3a illustrates a magnification error. In FIG. 3a, reference 301 stands for a pixel of the detector 314, reference 302 for an active area of the pixel 301, reference 303 for a bit of an imaged data page and reference 304 for an overlap area between a bit 303 and an active area 302. In the example of FIG. 3, the imaged data page is larger than the detector 114 in the X direction, due to a magnification error. As a consequence, it can be seen that a bit 303 does not impinge on a single pixel 301, but may impinge on 2 pixels 301.

FIG. 3b represents the intensity of the pixels of the detector of FIG. 3a, in the X direction. The intensity of a pixel is proportional to the surface of the overlap area 304. It can be seen that the intensity is periodic, the period being dependent on the error in magnification. As a consequence, detecting the period of the intensity of the detected imaged data page gives an information on the magnification error. FIG. 3b shows a simple case of a Moiré pattern. More complicated Moiré patterns may be detected in accordance with the invention. Examples of such Moiré patterns are given in the following Figs.

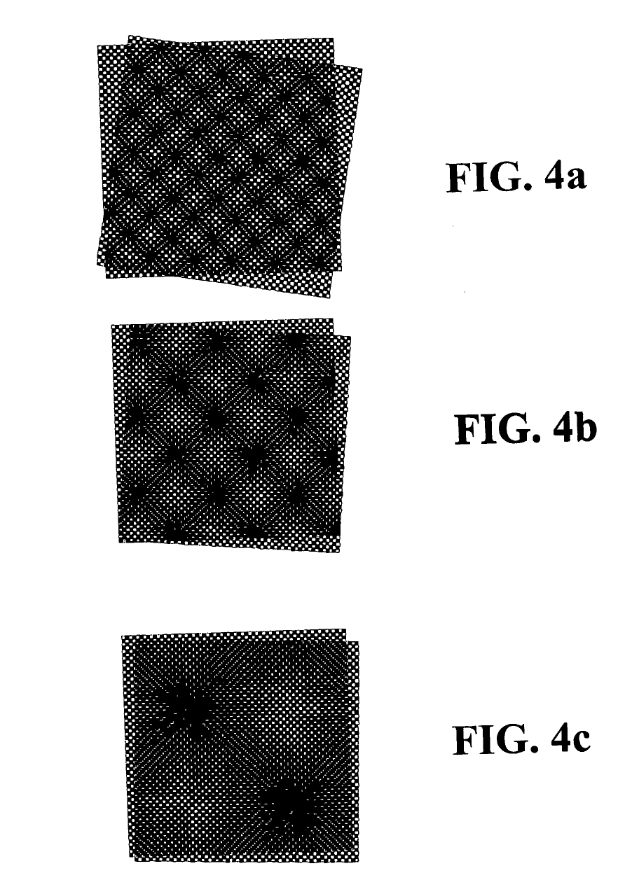

FIG. 4a illustrates a Moiré pattern which is detected when an angular error occurs in the holographic device. In FIG. 4a, the imaged data page makes an angle of 10 degrees with respect to the detector 114. As can be seen from FIG. 4a, the detected imaged data page comprises a Moiré pattern. In FIG. 4b, the angle error is 5 degrees and in FIG. 4c the angle error is 2 degrees. It can be seen that the period of the Moiré pattern is different in these three Figs. As a consequence, the period of the Moiré pattern gives an information on the angle error, which can be used for correcting the position of the imaged data page with respect to the detector so as to suppress the angle error. In this case, the holographic medium 106 may be rotated until the period of the Moiré pattern becomes infinite, which means that there is no angle error between the image data page and the detector 114.

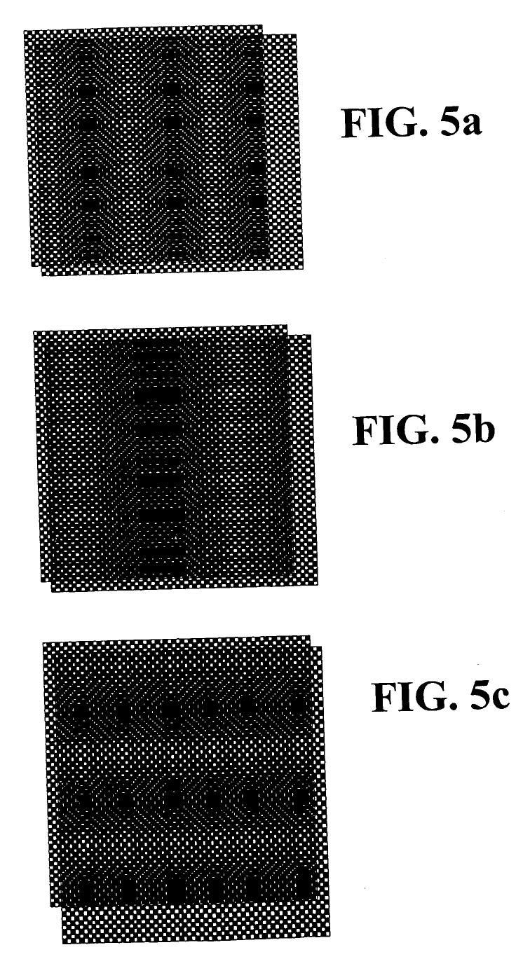

FIG. 5a illustrates a Moiré pattern which is detected when a magnification error occurs in the holographic device. In FIG. 5a, the bits of the imaged data page are 10 percent larger than the pixels of the detector 114 in a first direction. As can be seen from FIG. 5a, the detected imaged data page comprises a Moiré pattern, which comprises stripes oriented in a direction perpendicular to said first direction. In FIG. 5b, the difference in size is 5 percent. It can be seen that the period of the Moiré pattern is different in these two Figs. As a consequence, the period of the Moiré pattern gives an information on the magnification error, which can be used for correcting the magnification of the imaged data page so as to suppress the magnification error. In FIG. 5c, the bits of the imaged data page are 10 percent larger than the pixels of the detector 114 in a second direction perpendicular to the first direction. As can be seen from FIG. 5c, the detected imaged data page comprises a Moiré pattern, which comprises stripes oriented in a direction perpendicular to said second direction.

From FIG. 5a to 5c, it is clear that the orientation of the Moiré patterns depends on the nature of the magnification. Detection of the orientation of the Moiré patterns thus gives an information on the kind of magnification correction to be applied.

An example of procedure that can be applied for correcting angle and magnification errors is described hereinafter. First, the Moiré pattern is detected. The imaged data page is then rotated. If the angle of the Moiré pattern varies, then it means that there is a magnification error. The horizontal magnification is then corrected until the period of the Moiré pattern becomes maximum, and the vertical magnification is then corrected until the period of the Moiré pattern becomes maximum. Finally, the imaged data page is rotated until the period of the Moiré pattern becomes infinite.

A plurality of procedures for compensating for magnification and angle corrections based on detection of Moiré patterns may be applied. The above-described procedure thus constitutes only an example.

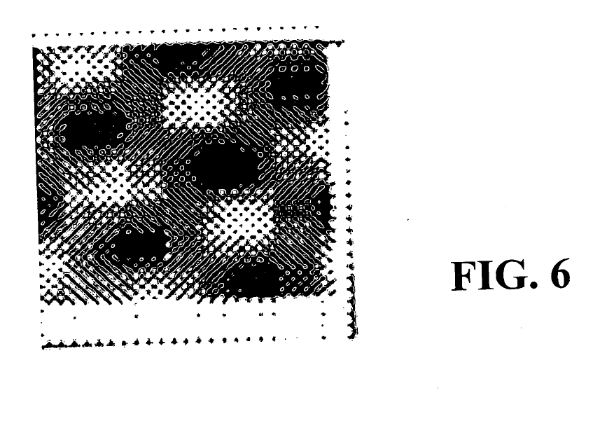

Advantageously, the detected imaged data page is filtered before detection of Moiré patterns. By filtration of the high frequency components, the Moiré patterns can be detected more easily. FIG. 6 shows a detected imaged data page comprising an angle error and a magnification error, where the high frequency components have been filtered. It can be seen that detection of a Moiré pattern is easier and will thus require less signal processing after the detector 114.

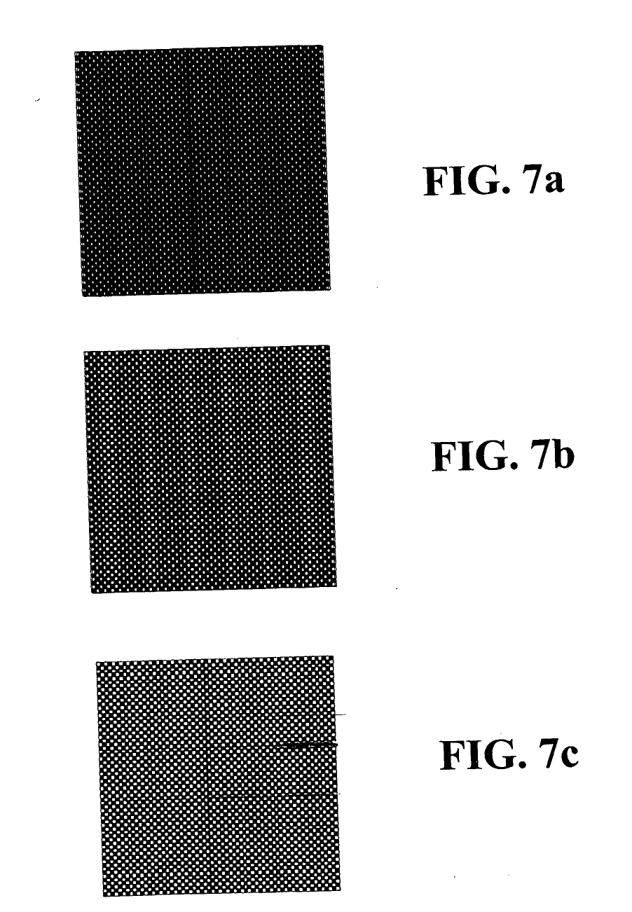

FIG. 7a to 7c illustrate Moiré patterns which are detected when a translation error occurs in the holographic device. In FIG. 7a, there is a shift of half a pixel between the bits of the imaged data page and the pixels of the detector 114. In FIG. 4b, the shift is a quarter of a pixel and in FIG. 4c there is no shift. It can be seen that the global intensity on the detector 114 is different. Hence, measuring the intensity on the detector 114 gives an information on the translation error, which can be used for correcting the position of the imaged data page with respect to the detector 114. This is also considered as a Moiré pattern, but with a period that is larger than the size of the detector 114. Hence, in FIG. 7a to 7c, a Moiré pattern is also detected, but only a portion of this Moiré pattern is used for modifying the imaged data page.

Advantageously, the holographic device further comprises means for measuring a contrast in the detected imaged data page. By measurement of the contrast in the detected imaged data page, an information is obtained on the focus of said imaged data page on the detector 114. The contrast is maximum when the imaged data page is focused on the detector 114.

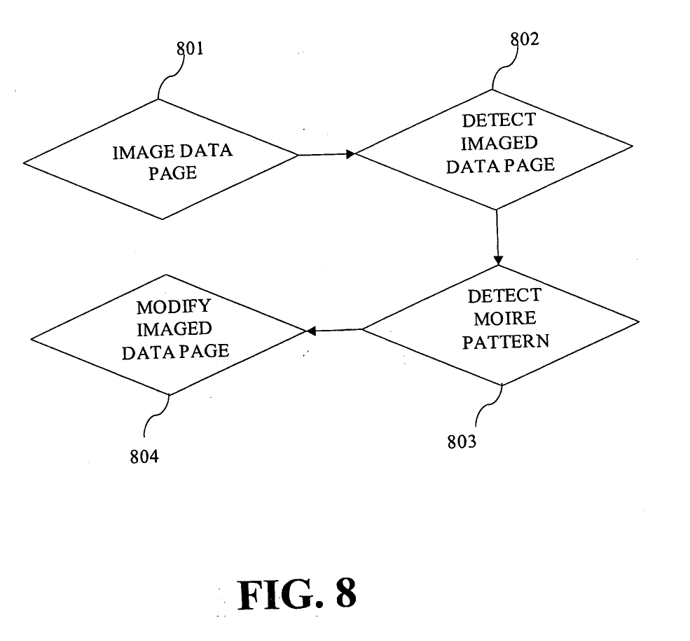

FIG. 8 illustrates the method of reading out a holographic medium in accordance with the invention. At step 801, a data page is imaged and an imaged data page is thus formed on the detector 114. This imaged data page is detected at step 802, and analyzed in order to detect a Moiré pattern at step 803. The imaged data page is finally modified at step 804, said modification being dependent on said Moiré pattern. For example, if an angle error is detected such as described in FIGS. 4a to 4c, a deflector can be used in order to rotate the imaged data page until no angle error is detected. To this end, a servo circuit analyses the Moiré pattern and drives an actuator as a function of said Moiré pattern.

The method for reading out a data page according to the invention can be implemented in an integrated circuit, which is intended to be integrated in an holographic device. A set of instructions that is loaded into a program memory causes the integrated circuit to carry out the method for reading out the data page. The set of instructions may be stored on a data carrier such as, for example, a disk. The set of instructions can be read from the data carrier so as to load it into the program memory of the integrated circuit, which will then fulfil its role.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical holographic device for reading out a data page recorded in a holographic medium (106), said device comprising means (104, 105) for forming an imaged data page from said data page, means for detecting (114) said imaged data page, means for detecting a Moiré pattern in said detected imaged data page and means for modifying said imaged data page as a function of said Moiré pattern.

2. An optical holographic device as claimed in claim 1, wherein said means for modifying said imaged data page comprise means for changing the magnification of said imaged data page.

3. An optical holographic device as claimed in claim 1, wherein said means for modifying said imaged data page comprise means for translating said imaged data page.

4. An optical holographic device as claimed in claim 1, wherein said means for modifying said imaged data page comprise means for rotating said imaged data page.

5. An optical holographic device as claimed in claim 1, the means for detecting the Moiré pattern comprising means for filtering high frequency components of the detected imaged data page.

6. An optical holographic device as claimed in claim 1, further comprising means for measuring a contrast in the detected imaged data page, the means for modifying the imaged data page being further controlled by said contrast.

7. A method for reading out a data page recorded in a holographic medium, said method comprising a step (801) of forming an imaged data page from said data page, a step (802) of detecting said imaged data page, a step (803) of detecting a Moiré pattern in said detected imaged data page and a step (804) of modifying said imaged data page as a function of said Moiré pattern.

8. A computer program comprising a set of instructions which, when loaded into a processor or a computer, causes the processor or the computer to carry out the method as claimed in claim 7.
